(19) United States
(12) Patent Application Publication
(10) Pub. No.: US 2026/0087776 A1
(43) Pub. Date: Mar. 26, 2026

(54) SELECTIVE MULTI-VIEW DEEP MODEL FOR 3D OBJECT CLASSIFICATION

(71) Applicants: KING FAHD UNIVERSITY OF PETROLEUM AND MINERALS, Dhahran (SA); Saudi Data and Artificial Intelligence Authority (SDAIA), Riyadh (SA)

(72) Inventors: Mona Saleh Ahmad ALZAHRANI, Dhahran (SA); Muhammad USMAN, Dhahran (SA); Saeed ANWAR, Dhahran (SA); Tarek Ahmed Helmy EL-BASSUNY, Dhahran (SA)

(73) Assignees: KING FAHD UNIVERSITY OF PETROLEUM AND MINERALS, Dhahran (SA); Saudi Data and Artificial Intelligence Authority (SDAIA), Riyadh (SA)

(21) Appl. No.: 18/891,586

(22) Filed: Sep. 20, 2024

(51) Int. Cl. G06V 10/764; B25J 9/16; G06T 17/00; G06V 10/44; G06V 10/74; H04N 13/351

(52) U.S. Cl. CPC G06V 10/764; B25J 9/1669; G06T 17/00; G06V 10/44; G06V 10/761; H04N 13/351

(57) ABSTRACT

A selective multi-view method and a 3D object recognition subsystem for 3D object classification. The method includes inputting, by a 3D imaging sensor, a 3D data representation of a 3D object, extracting, by processing circuitry, multiple view images from the 3D data representation of the 3D object, selecting, by the processing circuitry, a most influential view based on an assignment of importance scores using a Cosine similarity method between visual features detected by at least one pre-trained convolutional neural network (CNN). The method further includes predicting, by the processing circuitry, a classification of the 3D object based on the selected most influential view and outputting, by the processing circuitry, a class of the 3D object. The subsystem may be implemented for a robotic pick and place manipulator.

### STATEMENT REGARDING PRIOR DISCLOSURE BY THE INVENTORS

Aspects of this technology are described in an article “Selective Multi-View Deep Model for 3D Object Classification (SelectiveMV)” by Mona Alzahrani, Muhammad Usman, Saeed Anwar, and Tarek Helmy, CVPR 2024 and published online Apr. 23, 2024 in arXiv 2404 15224, and is herein incorporated by reference in its entirety.

### STATEMENT OF ACKNOWLEDGEMENT

The authors would like to acknowledge the support provided by Saudi Data and AI Authority (SDAIA) and King Fahd University of Petroleum and Minerals (KFUPM) under SDAIA-KFUPM Joint Research Center for Artificial Intelligence Grant no. JRC-AI-RFP-19, for supporting this work.

### BACKGROUND

### Technical Field

The present disclosure is directed to the field of three-dimensional (3D) object recognition and classification. More specifically, the present disclosure relates to systems and methods for classifying 3D objects using selective multi-view deep learning techniques in robotic and computer vision applications.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Three-dimensional (3D) object classification plays a crucial role in 3D computer vision, encompassing the recognition and categorization of three-dimensional objects based on their specific categories, in a manner that identifies features that may not be recognized in 2D images. This task holds significant practical implications for a wide range of real-world applications, including medical image analysis, automated driving, intelligent robots, virtual reality, crowd surveillance, virtual reality, augmented reality, and many more, where features including depth, texture, and size are needed. The ability to accurately recognize and categorize 3D objects is fundamental to enabling machines to interact with and understand their environment in a manner similar to human perception. 3D object classification methods are developed based on the representation of the 3D object. According to these 3D representations, 3D object classification methods can be categorized by works to three methods: i) voxel-based (also called volumetric-based) methods, where the input object can be represented as a 3D regular grid called a voxel; ii) point-based methods, where the input representation is a point cloud or unordered point sets; or iii) view-based methods, where the object is rendered through its projected 2D multi-view images. Among the 3D object classification methods, the view-based methods have performed best so far and achieved the current state-of-the-art performance.

The idea of view-based 3D object classification methods proposed by Multi-View Convolutional Neural Network (MVCNN) [See: Hang Su, Subhransu Maji, Evangelos Kalogerakis, and Erik Learned-Miller. 2015. Multi-view convolutional neural networks for 3d shape recognition. In Proceedings of the IEEE international conference on computer vision. 945-953, incorporated herein by reference in its entirety] describes work in the field. It collects information from multiple 2D views as a representation of a 3D object. Then, the 2D views are used later to generate a global shape descriptor for 3D object classification. However, MVCNN treated all views equally to extract the final shape descriptor, limiting these methods' performance. To tackle this issue, Feng et al. [See: Yifan Feng, Zizhao Zhang, Xibin Zhao, Rongrong Ji, and Yue Gao. 2018. GVCNN: Group-view convolutional neural networks for 3D shape recognition. In Proceedings of the IEEE Conference on Computer Vision and Pattern Recognition. 264-272] proposed a Group-View Convolutional Neural Network (GVCNN) framework that takes the correlation among the views into consideration by exploring the visual content relationship of these views and extracting the discriminative information from them. Despite this, MVCNN and GVCNN were assumed to be known poses from where a viewer observed the target object (aligned object).

However, in the real world, the viewer could observe the object only from partial viewpoints due to occlusions (unaligned objects), which makes depending on full multi-view images difficult. For that reason, Kanezaki et al. [See: Asako Kanezaki, Yasuyuki Matsushita, and Yoshifumi Nishida. 2018. RotationNet: Joint object categorization and pose estimation using multiviews from unsupervised viewpoints. In Proceedings of the IEEE Conference on Computer Vision and Pattern Recognition. 5010-5019, incorporated herein by reference in its entirety] proposed a view-based model called RotationNet for 3D object classification, 3D shape retrieval, and pose estimation tasks which dealt with the viewpoint labels as latent variables that were learned during the training using the unsupervised approach to best predict the object category. However, RotationNet depends on a homogeneous space assumption for view configurations. Compared with the above approaches, Wei et al. [See: Xin Wei, Ruixuan Yu, and Jian Sun. 2020. View-gcn: View-based graph convolutional network for 3d shape analysis. In Proceedings of the IEEE/CVF Conference on Computer Vision and Pattern Recognition. 1850-1859] introduced a view-based Graph Convolutional Neural Network (view-GCN) to recognize 3D shapes by taking multi-views of a 3D shape and represent them as a view-graph to enable Graph Convolutional Network (GCN) to hierarchically gather discriminative multi-view features considering the relations between views to form the global shape descriptor later. The evaluation experiments prove that view-GCN outperformed the traditional view-pooling approaches such as MVCNN and GVCNN, and the rotation optimization approaches such as RotationNet.

However, it has been noticed that most of the previously proposed methods rely on using all the captured views for classifying the 3D objects, which confuses the classifier and can be misleading for some classes. Some views are more discriminative for object classification. So, a selection mechanism is needed because not every view is useful for classification, and some views could confuse the classifier and can be misleading for some classes (e.g., looking from the bottom at a bed), some views are more discriminative for object classification, and processing all views needs a heavy computation and causes overhead. Moreover, from the classification performance of the view-based models when they were evaluated on the well-known ModelNet40 dataset, the best results obtained by RotationNet and View-GCN with 97.37% and 97.6% Overall Accuracy (OA), respectively, where both of them was using a selection mechanism. However, RotationNet did not represent an active complete selection mechanism [See: Shaohua Qi, Xin Ning, Guowei Yang, Liping Zhang, Peng Long, Weiwei Cai, and Weijun Li. 2021. Review of multi-view 3D object recognition methods based on deep learning. Displays (2021), 102053], and it does not guarantee correctly classifying the objects observed from a novel (not pre-defined) viewpoint for object classification, which is a limitation when there are only a few pre-defined viewpoints. While in View-GCN, its selective view sampling strategy requires at least 12 views [See: Abdullah Hamdi, Silvio Giancola, and Bernard Ghanem. 2021. MVTN: Multi-View Transformation Network for 3D Shape Recognition. In Proceedings of the IEEE/CVF International Conference on Computer Vision. 1-11].

To tackle the problem of using all the captured views for classifying the 3D objects, some view-based methods were initially proposed to use a selection mechanism for selecting the most discriminative views and using them for classification. While other view-based methods just experimented with a selection mechanism as part of their trials to test how classification performance would be affected if different numbers of views were used for prediction. Table 1 below summarized recent selective view-based 3D object classification methods that experimented with a single view regarding the dataset used, the selection mechanism, the number of training views, the backbone network, and the classification performance.

Optimal Viewset Pooling Transformer (OVPT) proposed by Wang et al. [See: Wenju Wang, Gang Chen, Haoran Zhou, and Xiaolin Wang. 2022. OVPT: Optimal Viewset Pooling Transformer for 3D Object Recognition. In Proceedings of the Asian Conference on Computer Vision. 4444-4461, incorporated herein by reference in its entirety] aims to improve the recognition performance by reducing the views' redundancy. OVPT has three modules; the first module captured the 20 spherical views from each 3D object and used information entropy as a selection mechanism to reduce the redundant views and gain the optimal view set. Then, the second module inputs the optimal views to pre-trained ResNet-34 as the backbone network for feature extraction that is later flattened into a local view token sequence so it can be input to the transformer. Finally, the last module is the pooling transformer that generates the global descriptors used for classification. As a result, it achieves 97.48% OA and 96.74% Average Accuracy (AA) on ModelNet40 with only six best views.

When OVPT experimented with a single tested view, it achieved 95.82% OA and 94.3% on a model trained with 20 views of the ModelNet40 dataset. Compared with other deep learning-based (DL-based) methods such as iMHL [See: Zizhao Zhang, Haojie Lin, Xibin Zhao, Rongrong Ji, and Yue Gao. 2018. Inductive multi-hypergraph learning and its application on view-based 3D object classification. IEEE Transactions on Image Processing 27, 12 (2018)] and RotationNet and other transformer-based methods such as MVDAN [See: Wenju Wang, Yu Cai, and Tao Wang. 2022. Multi-view dual attention network for 3D object recognition. Neural Computing and Applications 34, 4 (2022), 3201-3212] and MVMSAN [See: Wenju Wang, Xiaolin Wang, Gang Chen, and Haoran Zhou. 2022. Multi-view SoftPool attention convolutional networks for 3D model classification. Frontiers in Neurorobotics (2022), 255], OVPT achieves state-of-the-art performance in the multi-view 3D object classification accuracy with less redundant views and less computational resources.

On the other hand, other view-based methods also experimented with a selection mechanism to randomly select a single view to test how classification performance may be affected. A transformer-based MVT model [See: Shuo Chen, Tan Yu, and Ping Li. 2021. Mvt: Multi-view vision transformer for 3d object recognition. arXiv preprint arXiv:2110.13083 (2021)] achieved 85.19% when trained with 12 views extracted from the ModelNet10 dataset and then tested with a randomly selected single view. While MVCNN and DeepCCFV [See: Zhengyue Huang, Zhehui Zhao, Hengguang Zhou, Xibin Zhao, and Yue Gao. 2019. Deepccfv: Camera constraint-free multi-view convolutional neural network for 3d object retrieval. In Proceedings of the AAAI Conference on Artificial Intelligence, Vol. 33. 8505-8512, incorporated herein by reference in its entirety] also experimented with the same settings of 12 views for training and single random view for testing but with ModelNet40 dataset and achieved 64.28% and 82.11% OA, respectively, when the pre-trained VGG-11 was used as backbone network; and achieved 48.11% and 70.39% OA, respectively, when the pre-trained ResNet-50 was used. Also, ViewFormer [See: Hongyu Sun, Yongcai Wang, Peng Wang, Xudong Cai, and Deying Li. 2023. ViewFormer: View Set Attention for Multi-view 3D Shape Understanding. arXiv preprint arXiv:2305.00161 (2023)] was using a random selection to select a single view from 20 views extracted from each object belonging to the ModelNet40 dataset, and it was able to achieve 91.8% OA and 89% when the pre-trained ResNet-18 was used as the backbone network for feature extraction.

Even more, MVSG-DNN [See: He-Yu Zhou, An-An Liu, Wei-Zhi Nie, and Jie Nie. 2019. Multi-view saliency guided deep neural network for 3-D object retrieval and classification. IEEE Transactions on Multimedia 22, 6 (2019), 1496-1506] also trained with 20 views as OVPT and ViewFormer but tested with adaptively selected views using a saliency LSTM that was based on multi-view context by changing the view-wise weight distribution. Using this selection mechanism and AlexNet as the backbone network, MVSG-DNN achieved stable performance with 87% and 87.5% on ModelNet10 and ModelNet40, respectively, using only a single view for classification.

TABLE 1
Selective view-based 3D object classification methods experimented with a single
view (OA: Overall Accuracy, AA: Average Accuracy, DL: Deep Learning).

| Selective | | Model | Selection | ModelNet | | | Training | Feature |
|---|---|---|---|---|---|---|---|---|
| Model | Year | Type | Mechanism | 10 | 40v1 | 40v2 | Views | Extractor |
| MVSG- | 2019 | DL | Saliency | ✓ | | | 20 views | AlexNet |
| DNN | | | LSTM | | | | | |
| MVSG- | 2019 | DL | Saliency | | | ✓ | 20 views | AlexNet |
| DNN | | | LSTM | | | | | |
| MVCNN | 2019 | DL | Random | | ✓ | | 12 views | VGG-11 |
| | | | selection | | | | | |
| MVCNN | 2019 | DL | Random | | ✓ | | 12 views | ResNet- |
| | | | selection | | | | | 50 |
| DeepCCFV | 2019 | DL | Random | | ✓ | | 12 views | VGG11- |
| | | | selection | | | | | BN |

Based on the above, among the 3D object classification methods, the view-based methods have performed best so far and achieved the current state-of-the-art performance. However, current view-based 3D object classification methods often rely on using all captured views for classification, which can lead to information redundancy, increased computational overhead, and potential confusion for the classifier when dealing with certain object classes. Moreover, not all views of an object are equally informative or discriminative for classification purposes, and processing all views may introduce noise or irrelevant information into the classification process, which is not desirable.

Accordingly, it is one object of the present disclosure to provide an intelligent and efficient selective multi-view object classification model that can identify and utilize the most informative views of a 3D object while minimizing computational resources and improving classification accuracy. Such an approach would be particularly valuable in real-time applications such as robotic manipulation, where quick and accurate object recognition is required for effective interaction with the object.

### SUMMARY

In an exemplary embodiment, a selective multi-view method for 3D object classification is provided. The method comprises inputting, by a 3D imaging sensor, a 3D data representation of a 3D object. The method further comprises extracting, by processing circuitry, multiple view images from the 3D data representation of the 3D object. The method further comprises selecting, by the processing circuitry, a most influential view based on an assignment of importance scores using a Cosine similarity method between visual features detected by at least one pre-trained convolutional neural network (CNN). The method further comprises predicting, by the processing circuitry, a classification of the 3D object based on the selected most influential view. The method further comprises outputting, by the processing circuitry, a class of the 3D object.

In some embodiments, the method further comprises controlling a robotic manipulator to grasp the 3D object based on the object class.

In some embodiments, the method further comprises feature extracting by the at least one pre-trained CNN ψ, a stack of feature maps fmᵢ of a detected visual feature from the extracted multiple view images Vᵢ before the predicting by a classification model.

In some embodiments, the method further comprises comparing feature vectors obtained by the feature extracting based on their similarity using the Cosine Similarity, and assigning an importance score to each feature vector.

In some embodiments, the method further comprises determining the importance score I of each feature vector fv as a Cosine distance between current fvᵢ and all other feature vectors.

In some embodiments, the method further comprises selecting the feature vector with highest importance score, Most Similar View (MSV), as the most influential view.

In some embodiments, the method further comprises selecting the feature vector with lowest importance score, Most Dissimilar View (MDV), as the most influential view.

In some embodiments, the extracting step extracts the multiple view images from a perspective of an arrangement of a plurality of virtual cameras arranged at positions irregularly spherical around the 3D object.

In some embodiments, the extracting step extracts the multiple view images from a perspective of an arrangement of a plurality of virtual cameras arranged at positions in a circle around the 3D object.

In some embodiments, the method further comprises classifying, by a fully connected layer, the 3D object.

In another exemplary embodiment, a 3D object recognition subsystem for a robotic pick and place manipulator is provided. The subsystem comprises a 3D imaging sensor obtaining a 3D data representation of a 3D object. The subsystem further comprises processing circuitry. The processing circuitry is configured to extract multiple view images from the 3D data representation of the 3D object. The processing circuitry is further configured to select a most influential view based on an assignment of importance scores using a Cosine similarity method between visual features detected by at least one pre-trained convolutional neural network (CNN). The processing circuitry is further configured to predict a classification of the 3D object based on the selected most influential view. The processing circuitry is further configured to output a class of the 3D object. The processing circuitry is further configured to control the robotic manipulator to grasp the 3D object based on the object class.

In some embodiments, the processing circuitry is further configured to extract the multiple view images from a perspective of an arrangement of a plurality of virtual cameras.

In some embodiments, the processing circuitry is further configured to extract by the at least one pre-trained CNN ψ, a stack of feature maps fmᵢ of the detected visual feature from the extracted multiple view images Vᵢ before the predicting by a classification model.

In some embodiments, the processing circuitry is further configured to compare feature vectors obtained by the feature extraction based on their similarity using the Cosine Similarity, and assign an importance score to each feature vector.

In some embodiments, the processing circuitry is further configured to determine the importance score I of each feature vector fv as a Cosine distance between current fvᵢ and all other feature vectors.

In some embodiments, the processing circuitry is further configured to select the feature vector with highest importance score, Most Similar View (MSV), as the most influential view.

In some embodiments, the processing circuitry is further configured to select the feature vector with lowest importance score, Most Dissimilar View (MDV), as the most influential view.

In some embodiments, the arrangement of the plurality of virtual cameras is virtual cameras arranged at positions irregularly spherical around the 3D object.

In some embodiments, the arrangement of the plurality of virtual cameras is virtual cameras arranged at positions in a circle around the 3D object.

In some embodiments, the processing circuitry is further configured to classify, by a fully connected layer, the 3D object.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary flowchart of a selective multi-view method for 3D object classification, according to certain embodiments;

FIG. 2A illustrates examples of where neighboring views of exemplary 3D objects can be discriminative for 3D object classification, according to certain embodiments;

FIG. 2B illustrates examples of where symmetric views of exemplary 3D objects can be discriminative for 3D object classification, according to certain embodiments;

FIG. 3A illustrates an exemplary camera setup in the form of a regular circle for capturing 3D data representation of a 3D object, according to certain embodiments;

FIG. 3B illustrates an exemplary camera setup in the form of an irregular sphere for capturing 3D data representation of a 3D object, according to certain embodiments;

FIG. 4 illustrates an exemplary set of circular views obtained from sample objects and their corresponding importance scores, according to certain embodiments;

FIG. 5 is an exemplary schematic diagram of a 3D object recognition subsystem for an associated robotic pick and place manipulator, according to certain embodiments;

FIG. 6 is a flow diagram for a method of predicting the class of a 3D object in the form of an example car, according to certain embodiments;

FIG. 7 is an exemplary schematic diagram of an architecture for a selective multi-view model, according to certain embodiments;

FIG. 8 illustrates exemplary samples of feature maps belonging to correctly classified labels, highlighted with the Grad-CAM technique, according to certain embodiments;

FIG. 9 illustrates exemplary multi-view samples from ModelNet40v1 dataset of most wrongly classified objects by the selective multi-view model, according to certain embodiments;

FIG. 10 illustrates exemplary input and output of the selective multi-view model, demonstrating processing of a 3D object to predict its category, according to certain embodiments;

FIG. 11A illustrates original shape representations for exemplary multi-view images, according to certain embodiments;

FIG. 11B illustrates shaded shape representations for exemplary multi-view images, according to certain embodiments;

FIG. 12 is an illustration of a non-limiting example of details of computing hardware used in the computing system, according to certain embodiments.

FIG. 13 is an exemplary schematic diagram of a data processing system used within the computing system, according to certain embodiments.

FIG. 14 is an exemplary schematic diagram of a processor used with the computing system, according to certain embodiments.

FIG. 15 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a selective multi-view method for 3D object classification and a 3D object recognition subsystem for a robotic pick and place manipulator. The present disclosure addresses the aforementioned challenges with existing 3D object classification techniques. The present disclosure utilizes an approach to extract multiple view images from a 3D data representation of an object and selects the most influential view based on an assignment of importance scores. This selection process employs a Cosine similarity method to compare visual features detected by pre-trained convolutional neural networks (CNNs). The present disclosure, by focusing on the most influential view, reduces computational complexity and improves efficiency, making it suitable for real-time applications.

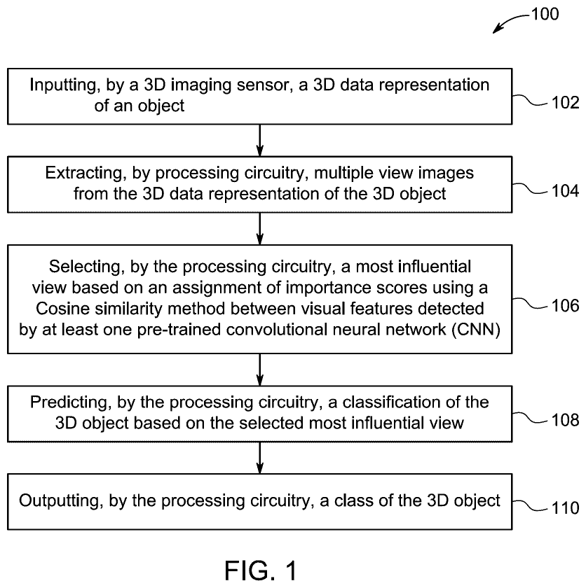

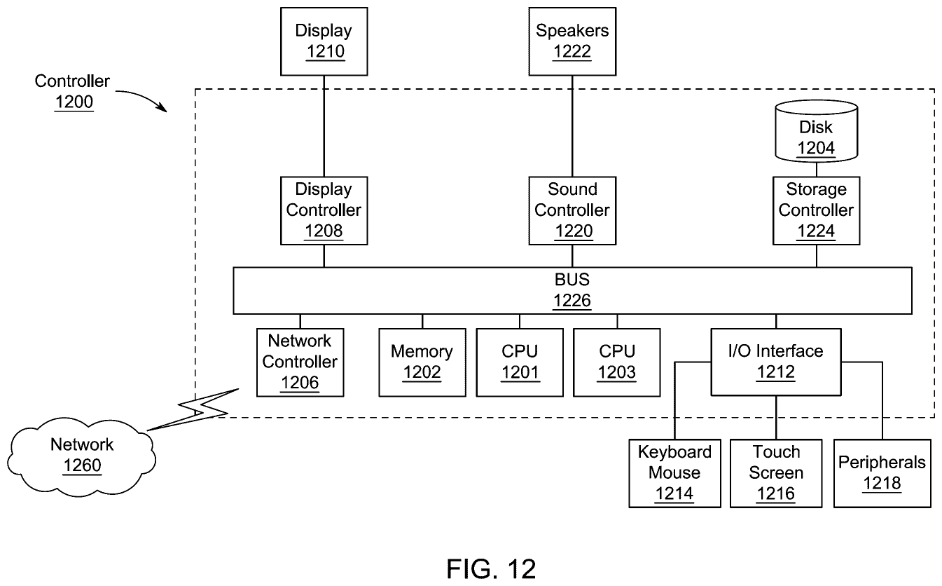

Referring to FIG. 1, illustrated is a flowchart of a selective multi-view method (as represented by reference numeral 100) for 3D object classification. The selective multi-view method 100 (hereinafter, referred to as “method 100”) comprises multiple steps for processing and classifying 3D objects. It should be understood that the method 100 is an algorithm that can be implemented as computer instructions executed in processing circuitry. The hardware aspects will be discussed later with respect to FIGS. 12-15. The method 100 utilizes a 3D data representation of an object to perform classification tasks. This method 100 employs a selective approach, focusing on extracting and analyzing multiple views of the 3D object. The method 100 incorporates techniques for evaluating the importance of different views and selecting the most influential view for classification purposes. By leveraging pre-trained convolutional neural networks (CNNs) and similarity measures, the method 100 aims to enhance the efficiency and accuracy of 3D object classification. The method 100 provides prediction and output of the 3D object's class, which can be utilized in various applications such as robotic manipulation, computer vision systems, and automated object recognition tasks. This method 100 is configured to optimize the classification process by concentrating on the most informative aspects of the 3D object, potentially reducing computational requirements while maintaining classification accuracy.

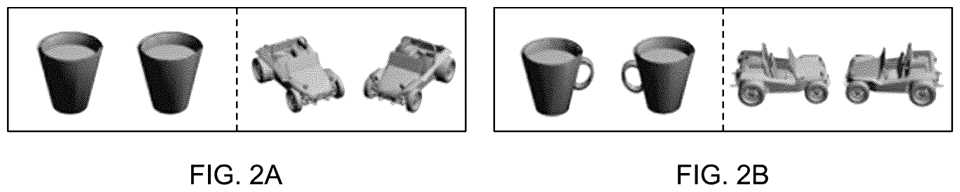

The method 100 addresses a challenge in 3D object classification, as illustrated in FIGS. 2A and 2B. These figures demonstrate the varying utility of multiple views for different types of objects. FIG. 2A presents a comparison between multiple neighboring views of a car and a cup. Herein, the multiple views of the car exhibit substantial differences in appearance and pose across different perspectives. These varied views provide highly discriminative details that are beneficial for accurate classification of the car. In contrast, the multi-views of the cup in FIG. 2A show minimal variation across different angles. The consistent appearance of the cup from multiple viewpoints offers limited additional information for classification purposes. This contrast highlights the need for a selective approach in utilizing multi-view data for 3D object classification. FIG. 2B presents a comparison between multiple symmetric views of a car and a cup. Herein, the multiple views of the cup reveal the cup's handle from certain angles. The visibility of the handle in these views provides a discriminative feature that allows for accurate classification of the cup. This example underscores the importance of capturing and selecting the most informative views for each object type. The method 100 is designed to address these variations in the discriminative power of different views, aiming to identify and utilize the most influential perspectives for each object being classified.

Referring back to FIG. 1, at step 102, the method 100 includes inputting, by a 3D imaging sensor, a 3D data representation of a 3D object. The 3D data representation is provided by the 3D imaging sensor configured to capture the three-dimensional structure that portrays depth characteristics of the object. The 3D imaging sensor can be implemented using various technologies such as structured light sensors, time-of-flight cameras, or laser scanners. These sensors are capable of capturing detailed spatial information about the object, including its shape, surface features, and relative distances of different parts of the object from the sensor. The 3D data representation typically consists of a point cloud or a mesh structure that accurately describes the geometry of the object in three-dimensional space. The depth characteristics are particularly important as depth for a more comprehensive understanding of the object's form and spatial relationships. This depth characteristics can be represented as distance values from the sensor to each point on the object's surface, providing a rich dataset for subsequent analysis. The 3D data representation serves as the foundation for the entire classification process, as it contains the raw information from which multiple views may be extracted and analyzed. The quality and resolution of this 3D data representation can significantly influence the accuracy of the subsequent classification steps. Therefore, the selection and calibration of the 3D imaging sensor are important considerations for effective implementation of the method 100.

At step 104, the method 100 includes extracting, by processing circuitry, multiple view images from the 3D data representation of the 3D object. This extraction process is performed by processing circuitry, which can be implemented using one or more processors, microcontrollers, application-specific integrated circuits (ASICs), field-programmable gate arrays (FPGAs), or any combination thereof (as discussed later in detail with reference to FIGS. 12-15). The processing circuitry is programmed to generate a set of 2D projections or renderings of the 3D object from different viewpoints. The extraction of multiple view images involves simulating the placement of virtual cameras around the 3D object. These virtual cameras are positioned at predetermined locations to capture different perspectives of the object. The number and arrangement of these virtual cameras can vary depending on the specific implementation of the method 100. For each virtual camera position, the processing circuitry generates a 2D projection of the 3D object. This projection simulates what the object would look like from that particular viewpoint. The processing circuitry may apply various rendering techniques to create these 2D images, such as depth mapping, shading, or texture mapping, depending on the available information in the 3D data representation. In some implementations of the method 100, the processing circuitry may also apply additional preprocessing techniques to the extracted view images. This can include resizing the images to a standard resolution, normalizing pixel values, or applying filters to enhance certain features. These preprocessing steps help to standardize the input for subsequent stages of the classification process.

The resulting set of multiple view images provides a comprehensive representation of the 3D object from different angles. Each view captures unique features and characteristics of the object, which can be important for accurate classification in later stages of the method 100. The number of views extracted can be adjusted based on the requirements of the specific application. While 12 views for the circular configuration and 20 views for the spherical configuration are typically obtained, the method 100 can be adapted to use different numbers of views. The choice of the number of views involves a trade-off between computational complexity and the level of detail captured about the object.

In case of a CAD model of the object being available, the multi-view extraction step may be done through Equation 1 (below) to extract m multi-view representation V₁, V₂, . . . , Vₘ from the CAD model Oₖ of the 3D object k. Where viewpoints (virtual cameras) with pre-defined angles (9) must be set up to render each view.

$$\{ {V}_{1} , {V}_{2} , … , {V}_{M} \} = φ ( {O}_{k} ) \qquad ( 1 )$$

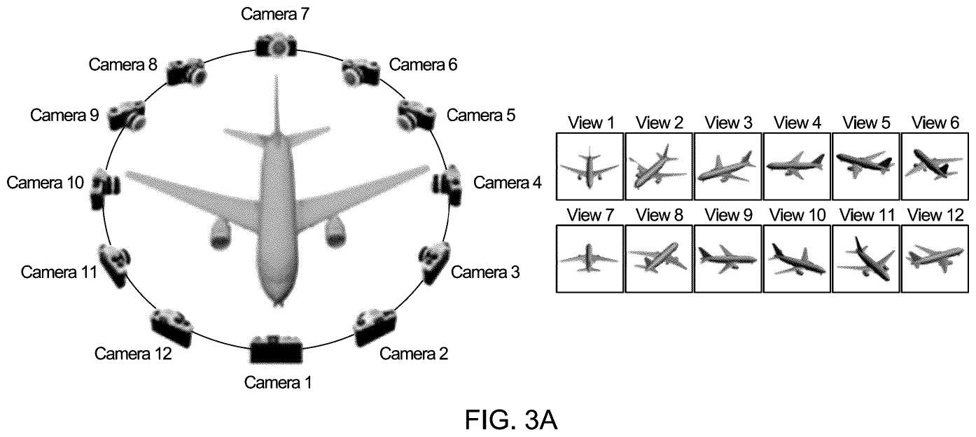

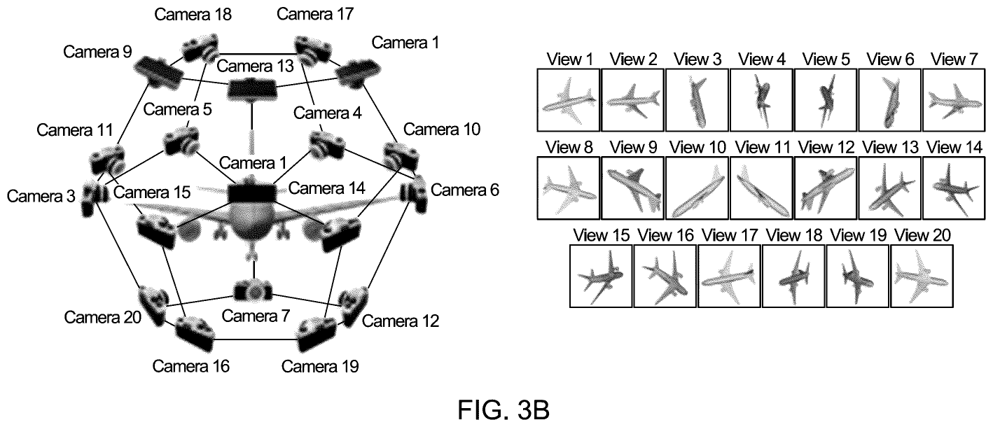

In the present implementations, as shown in FIGS. 3A and 3B, as a start, the circular configuration, where m is 12 extracted views, and the spherical configuration, where m is 20 extracted views, have been experimented since these are the camera settings that help to achieve the state-of-the-art performance in 3D object classification.

In a case of the circular configuration, the camera setup is in the form of a regular circle, as shown in FIG. 3A. Where the virtual cameras are regularly located on a horizontal circular path around the tested object and raised with elevation φ equal to 300 from the ground level and directed at the object's center. This setup is useful to capture views of aligned and real objects initially acquired with one-dimensional turning tables. In other words, it is beneficial when the objects are assumed to be with an upright orientation by a consistent axis (e.g., z-axis) as the rotation axis that identified the upright orientation where the virtual cameras are distributed over 30° at intervals of the azimuth angle Θ around the axis. Herein, the azimuth angle Θ is set equal to 30° as default, which means locating 12 virtual cameras that extracted 12 rendered views from an object. FIG. 3A shows samples of 12 extracted views when this circular configuration for the cameras is used. As may be understood, such circular configuration is particularly useful for capturing views of objects that have a consistent upright orientation.

In a case of the spherical configuration, the camera setup is typically in the form of an irregular sphere, as shown in FIG. 3B. This setup is without the consistent upright orientation assumption of shapes (the objects are unaligned and not in the same vertical direction). In this configuration, virtual cameras are irregularly located with equal spaces on the vertices of a dodecahedron/sphere surrounding the object. The camera viewpoints can be equally spread in 3D because a dodecahedron has the greatest vertices among regular polyhedral. This configuration was experimented, as View-GCN by locating 20 virtual cameras on the dodecahedron's vertices surrounding the object to render 20 views. FIG. 3B shows samples of 20 extracted views when this camera configuration is used. As may be understood, such spherical configuration is particularly useful for objects that may not have a consistent orientation or for capturing more diverse viewpoints.

Referring back to FIG. 1, at step 106, the method 100 includes selecting, by the processing circuitry, a most influential view based on an assignment of importance scores using a Cosine similarity method between visual features detected by at least one pre-trained convolutional neural network (CNN). As used herein, the most influential view represents the perspective of the 3D object that is deemed most informative or representative for the purpose of classification. The selection process utilizes the Cosine similarity method to evaluate and compare the visual features detected in each view. Cosine similarity is a mathematical measure that quantifies the similarity between two vectors by computing the cosine of the angle between them. In present context, the Cosine similarity method is used to assess how similar or dissimilar the features of one view are to those of other views. The visual features used in this comparison are detected by the at least one pre-trained CNN. A pre-trained CNN is a deep learning model that has been previously trained on a large dataset of images to recognize various visual patterns and features. These CNNs are capable of extracting high-level features from images, which can be more informative for classification tasks than raw pixel values. The importance scores assigned to each view are numerical values that reflect how representative or unique a particular view is compared to the others. The importance scores are calculated based on the Cosine similarity between the features of each view and those of all other views. The assignment of importance scores allows the method 100 to quantitatively evaluate the potential contribution of each view to the classification task. In general, by selecting the most influential view based on these importance scores, the method 100 aims to focus the classification process on the most informative perspective of the 3D object. This approach can potentially reduce computational complexity and improve classification accuracy by concentrating on the view that best captures the distinguishing characteristics of the object.

Herein, the selection of the most influential view involves several steps carried out by the processing circuitry. First, the method 100 includes feature extracting by the at least one pre-trained CNN ψ, a stack of feature maps fmᵢ of a detected visual feature from the extracted multiple view images Vᵢ before the predicting by a classification model. This feature extraction is carried out by the at least one pre-trained CNN, denoted as v. The pre-trained CNN ψ processes each of the extracted multiple view images Vᵢ to produce a stack of feature maps fmᵢ for each view. In this context, a feature map is a representation of detected visual features in the input image. The pre-trained CNN ψ generates multiple feature maps for each input view, with each feature map highlighting different aspects or patterns in the image. These feature maps collectively form a stack, representing a rich set of visual information extracted from the original view.

In the feature extraction process, the CNN y is pre-trained by the available and comprehensive 2D datasets such as ImageNet [See: Olga Russakovsky, Jia Deng, Hao Su, Jonathan Krause, Sanjeev Satheesh, Sean Ma, Zhiheng Huang, Andrej Karpathy, Aditya Khosla, Michael Bernstein, et al. 2015. Imagenet large scale visual recognition challenge. International journal of computer vision 115, 3 (2015), 211-252, incorporated herein by reference in its entirety] can benefit the several multi-view 3D object classification models by using them straightly as a backbone network. The backbone network can be a CNN architecture such as VGG [See: Karen Simonyan and Andrew Zisserman. 2014. Very deep convolutional networks for large-scale image recognition. arXiv preprint arXiv:1409.1556 (2014), incorporated herein by reference in its entirety], GoogLeNet [See: Christian Szegedy, Wei Liu, Yangqing Jia, Pierre Sermanet, Scott Reed, Dragomir Anguelov, Dumitru Erhan, Vincent Vanhoucke, and Andrew Rabinovich. 2015. Going deeper with convolutions. In Proceedings of the IEEE conference on computer vision and pattern recognition. 1-9, incorporated herein by reference in its entirety], and ResNet [See: Kaiming He, Xiangyu Zhang, Shaoqing Ren, and Jian Sun. 2016. Deep residual learning for image recognition. In Proceedings of the IEEE conference on computer vision and pattern recognition. 770-778, incorporated herein by reference in its entirety] that has been with excellent performance in 2D classification tasks. In this step, the role of the pre-trained CNN ψ is to extract the stack of feature maps fmᵢ of the detected visual feature from the rendered views Vᵢ at the beginning of the classification model as in Equation 2 (below) to save the training time, improve the classification accuracy, and reduce the complex 3D classification task to an easy 2D classification task.

$${fm}_{1} = ψ ( {V}_{1} ) , {fm}_{2} = ψ ( {V}_{2} ) , … , {fm}_{m} = ψ ( {V}_{m} ) \qquad ( 2 )$$

where fmᵢ is the stack of feature maps, ψ represents the pre-trained CNN, and Vᵢ is the input view image.

In this step of the disclosed multi-view 3D object classification model, different CNN architectures pre-trained on ImageNet have been experimented with to find the best feature extractor among them. The experiment-determined CNNs as feature extractors were: VGG-16, VGG-19, GoogLeNet (InceptionV3) [See: Christian Szegedy, Vincent Vanhoucke, Sergey Ioffe, Jon Shlens, and Zbigniew Wojna. 2016. Rethinking the inception architecture for computer vision. In Proceedings of the IEEE conference on computer vision and pattern recognition. 2818-2826, incorporated herein by reference in its entirety], ResNet-50, and ResNet-152. Table 2 (below) summarized the details of feature extractors CNNs, including their size, number of total layers, number of trainable parameters, and the shape of each extracted feature map in the form of rows×columns×channels.

TABLE 2
Details of the pre-trained CNNs that
experimented as feature extractors

| | | Size | No. of | Trainable | Feature Map |
|---|---|---|---|---|---|
| ID | Pre-Trained CNN | (MB) | Layers | Parameters | Shape |
| 1 | VGG-16 | 56.4 | 19 | 14,714,688 | 7 × 7 × 512 |
| 2 | VGG-19 | 76.7 | 22 | 20,024,384 | 7 × 7 × 512 |
| 3 | ResNet-50 | 93.8 | 175 | 23,534,592 | 7 × 7 × 2048 |
| 4 | ResNet-152 | 234 | 515 | 58,219,520 | 7 × 7 × 2048 |
| 5 | GoogLeNet | 88.8 | 311 | 21,768,352 | 5 × 5 × 2048 |

This feature extraction step transforms the raw pixel data of the view images into high-level feature representations. The method 100, by utilizing the pre-trained CNNs for feature extraction, leverages transfer learning, potentially improving performance even with limited training data. The extracted features capture complex patterns and structures in the images that are more suitable for the subsequent steps of the method 100, including the selection of the most influential view and the final classification of the 3D object.

The method 100 further includes a vectorization step that follows the feature extraction process. This vectorization step is performed by processing circuitry and involves converting the stack of feature maps for each view into a feature vector. In this phase, each feature map fm; may be flattened [symbol] to be treated as the feature vector fv; as in Equation 3 (below). The objective of this phase is to enable the next phase to compare the different feature vectors using Cosine similarity.

$${fv}_{1} = ϱ ( {fm}_{1} ) ; {fv}_{2} = ϱ ( {fm}_{2} ) ; … ; {fv}_{m} = ϱ ( {fm}_{m} ) \qquad ( 3 )$$

where fv is the resulting feature vector, Q represents the vectorization operation, and fmₘ is the input stack of feature maps for a given view.

The vectorization step enables the Cosine similarity calculations. Cosine similarity is defined for vector inputs, and by converting the feature maps to vectors, the method 100 can directly apply this similarity measure to compare different views. Moreover, the vectorization process helps to standardize the representation of features across different views and potentially different CNN architectures. This standardization ensures consistent processing in the subsequent steps of the method 100, regardless of the specific architecture of the pre-trained CNN used for feature extraction.

The method 100, then, includes comparing feature vectors obtained by the feature extracting based on their similarity using the Cosine Similarity, and assigning an importance score to each feature vector. This comparison is performed by processing circuitry and is based on the similarity between feature vectors using the Cosine similarity method. The Cosine similarity is a mathematical method that quantifies the similarity between two vectors by calculating the cosine of the angle between them. In the context of the method 100, each feature vector represents a different view of the 3D object. The comparison process involves calculating the Cosine Similarity between each feature vector and all other feature vectors extracted from the same 3D object.

Herein, the method 100 includes determining the importance score I of each feature vector fv as a Cosine distance between current fvᵢ and all other feature vectors. For this purpose, the method 100 involves a view selection phase. In this phase, the processing circuitry assigns an importance score I; to each feature vector fvᵢ by comparing it to all other feature vectors. The importance score I of each feature vector fvᵢ is calculated as the Cosine distance between the current feature vector fvᵢ and all other feature vectors, as done by Yang and Wang [See: Ze Yang and Liwei Wang. 2019. Learning relationships for multi-view 3D object recognition. In Proceedings of the IEEE/CVF International Conference on Computer Vision. 7505-7514, incorporated herein by reference in its entirety]. This calculation can be represented by the equations:

$$\{ {I}_{1} , {I}_{2} , … , {I}_{m} \} = λ \{ {fv}_{1} , {fv}_{2} , … , {fv}_{m} \} \qquad ( 4 )$$

$${I}_{i} = {\sum }_{i = 1}^{m} 1 - \frac{{fv}_{i} \cdot {fv}_{j}}{max ( ‖ {fv}_{i} ‖ ‖ {fv}_{i} ‖ , ε )} \qquad ( 5 )$$

The importance scores of the views that belong to the same object are normalized using Sum normalization β (see Equation 6 below) to ensure that the sum is always one. The normalized score [symbol] ; is calculated as in Equation 7 below. In other words, each view may be compared to all different views extracted from the same 3D object to give this view an important score.

$$\{ {Î}_{1} , {Î}_{2} , … , {Î}_{m} \} = β \{ {I}_{1} , {I}_{2} , … , {I}_{m} \} \qquad ( 6 )$$

$${Î}_{i} = \frac{{I}_{j}}{{\sum }_{j = 1}^{v} {I}_{j}} \qquad ( 7 )$$

The importance score reflects how similar or dissimilar a particular view is to all other views of the same object. A higher importance score typically indicates that a view is more representative of the object as a whole, as it shares more similarities with other views. The method 100, by quantifying the similarity relationships between different views of the same object, can identify which views are most representative or unique, and therefore potentially most useful for the classification task (as discussed in the proceeding paragraphs).

The method 100, then, includes selecting the feature vector as the most influential view. That is, finally, the best discriminative view may be selected using selection technique β in Equation 8 below based on its importance score and considered as a global descriptor Gₖ of the 3D object Oₖ.

$${G}_{k} = ξ \{ {Î}_{1} , {Î}_{2} , … , {Î}_{m} \} \qquad ( 8 )$$

In present embodiments, the method 100 includes two alternative approaches for selecting the most influential view based on the assigned importance scores. These approaches are implemented by the processing circuitry after the comparison of feature vectors and assignment of importance scores.

In one embodiment, the method 100 includes selecting the feature vector with highest importance score, referred to as Most Similar View (MSV), as the most influential view. In this first approach, the processing circuitry selects the feature vector with the highest importance score as the most influential view. Herein, the MSV is the view that has the higher cosine similarity (higher important score). This first approach of selection technique, β, considers the MSV as the best discriminative view because it could contain most of the features on other views corresponding to the same object, making it a comprehensive representation of the object for classification purposes.

In the second approach, the method 100 includes selecting the feature vector with lowest importance score, referred to as Most Dissimilar View (MDV), as the most influential view. In this second approach, the processing circuitry selects the feature vector with the lowest importance score as the most influential view. Herein, the MDV is the view that has the lower cosine similarity (lower important score). This second approach of selection technique, β, considers the MDV as the best discriminative view because it could contain the unique and irredundant features of other views corresponding to the same object, potentially providing distinctive information for classification.

The method 100 allows for experimentation with both approaches to determine which selection technique yields better classification results for different types of objects or datasets. The choice between MSV and MDV can depend on factors such as the nature of the objects being classified, the specific requirements of the application, and the characteristics of the dataset being used.

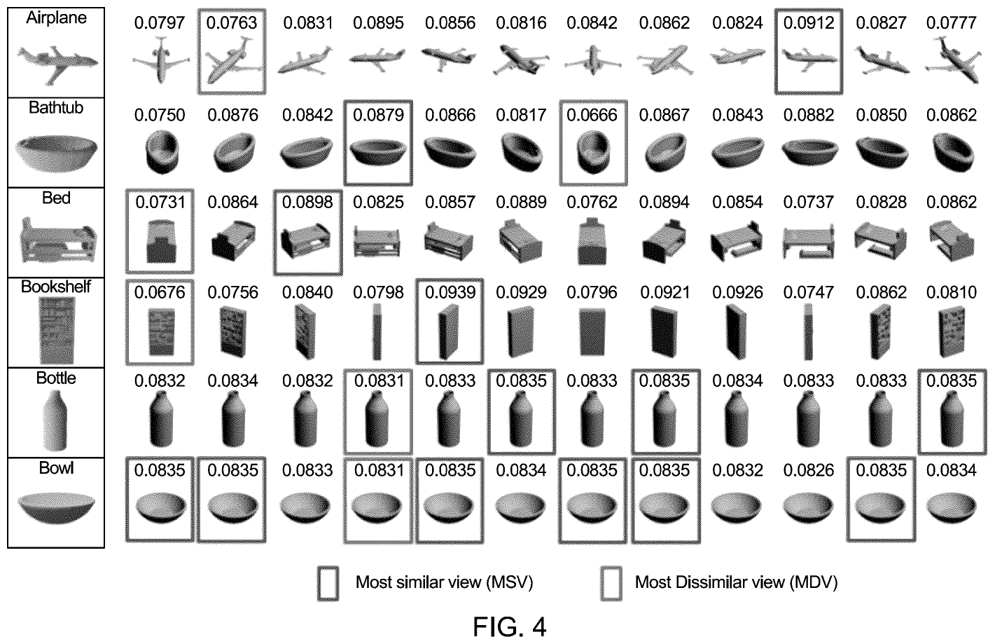

In practice, as illustrated in FIG. 4, the processing circuitry applies these selection techniques to the multiple views of each 3D object. FIG. 4 provides a set of 12 circular views obtained from sample objects, and their corresponding importance scores are displayed therewith. The views with the highest importance scores, representing the MSV, are highlighted with darker-shaded boxes. Conversely, the views with the lowest importance scores, representing the MDV, are highlighted with lighter-shaded boxes. In cases where multiple views have very similar importance scores, such as for highly symmetrical objects like ‘bottles’ or ‘bowls’ (as may be seen in last two rows from FIG. 4), multiple candidate MSVs or MDVs may be identified. In such scenarios, the method 100 may randomly select one view from the set of candidates with the highest (for MSV) or lowest (for MDV) importance scores.

Referring back to FIG. 1, at step 108, the method 100 includes predicting, by the processing circuitry, a classification of the 3D object based on the selected most influential view. This prediction is performed by the processing circuitry using the feature vector of the most influential view, whether it is the MSV or the MDV, as determined in the previous step. The prediction process utilizes a classification model (hereinafter, sometimes, referred to as “classifier” without any limitations). In the present embodiments, the method 100 includes classifying, by a fully connected layer, the 3D object. In particular, herein, the classification model can be implemented as either a Fully Connected Layer (FCL) or a Fully Connected Network (FCN). The FCL consists of a single fully connected layer with softmax activation, while the FCN contains a fully-connected layer of 1024 neurons with ReLU activation and 0.5 dropout probability, followed by another fully-connected layer with softmax activation. The classification step can be formally represented by the equation:

$${C}_{k} = δ ( {G}_{k} ) \qquad ( 9 )$$

where Cₖ is the predicted class of the 3D object Oₖ, δ represents the classifier (either FCL or FCN), and Gₖ is the global descriptor, which is the feature vector of the selected most influential view.

The classifier is trained using the feature vectors extracted from the training dataset. During the training phase, the classifier learns to map the high-level features represented in the feature vectors to specific object classes. In the prediction phase, the classifier applies this learned mapping to the feature vector of the most influential view to determine the most likely class for the input 3D object. Table 3 (below) details the layers of the classifiers with their output shape and activation function.

TABLE 3
Details of the deep learning networks and their
layers that are experimented with as classifiers.

| Classifier | Layers | Output Shape | Activation |
|---|---|---|---|
| FCL | Dense | (None, 40) | Softmax |
| FCN | Dense | (None, 1024) | ReLU |
| | Dropout | (None, 1024) | — |
| | Dense | (None, 40) | Softmax |

At step 110, the method 100 includes outputting, by the processing circuitry, a class of the 3D object. This output is generated by the processing circuitry based on the classification prediction made in the previous step. The output class represents the category or label assigned to the input 3D object by the classification model. This output is typically in the form of a discrete class label, corresponding to one of the predefined categories in the classification scheme. For example, in the context of the ModelNet40 dataset (as discussed), the output could be one of 40 object categories such as “chair”, “table”, “car”, or “bottle”.

The processing circuitry may present this output in various formats depending on the specific implementation and application requirements, such as, a single class label representing the most likely category for the 3D object; a probability distribution over all possible classes, indicating the likelihood of the object belonging to each category; a ranked list of top N most likely classes, along with their associated probabilities or confidence scores. The method 100 is designed to produce accurate and reliable classification outputs by leveraging the most influential view of the 3D object. This approach aims to enhance the overall performance of 3D object classification tasks in various applications.

The output generated by the processing circuitry can be used for various purposes. In an implementation, the method 100 includes controlling a robotic manipulator to grasp the 3D object based on the object class. This implementation extends the application of the 3D object classification beyond mere recognition to enable physical interaction with the classified object. Herein, the processing circuitry utilizes the output class of the 3D object to generate appropriate control signals for the robotic manipulator. The robotic manipulator can be any mechanical system capable of grasping and manipulating objects, such as a robotic arm with an end effector or gripper. Such control process may involve several sub-steps. First, the processing circuitry interprets the output class to determine the appropriate grasping strategy. Different object classes may require different grasping techniques. For example, a “cup” may be grasped from the side, while a “book” may be picked up from the top. Based on the determined grasping strategy, the processing circuitry generates a set of motion commands for the robotic manipulator. These commands specify the trajectory, orientation, and gripper configuration required to successfully grasp the object. The processing circuitry then sends these commands to a control system of the robotic manipulator. Finally, the control system executes the received commands, moving the robotic manipulator to approach and grasp the 3D object. This capability is particularly useful in scenarios such as automated warehousing, manufacturing assembly lines, or any application where robots need to interact with a variety of object types in their environment.

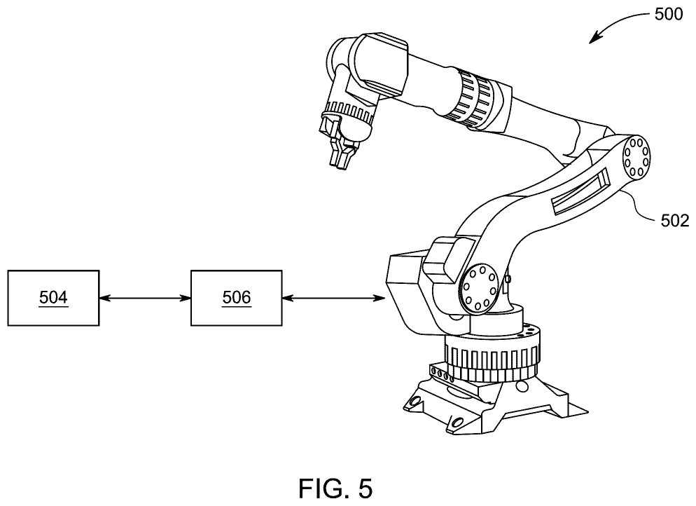

As illustrated in FIG. 5, the present disclosure further provides a 3D object recognition subsystem (as represented by reference numeral 500, and hereinafter referred to as “subsystem 500” without any limitations). In the present disclosure, the subsystem 500 is described to be implemented for a robotic pick and place manipulator 502 (hereinafter, sometimes, referred to as “robotic manipulator 502” without any limitations). For the sake of brevity and to avoid unnecessary repetition, detailed descriptions of certain aspects of the subsystem 500 have been omitted in the below section. These omitted details include, but are not limited to, the specific algorithms for feature extraction, the mathematical formulations of the Cosine similarity calculations, the detailed architectures of the pre-trained CNNs, the exact process of importance score normalization, and the details of the classification models. The omission of these details in the description of the subsystem 500 is solely for the purpose of clarity and conciseness, and does not imply any limitation on the capabilities or potential implementations of the subsystem 500. The subsystem 500 embodies the previously described concepts and processes in a hardware implementation. Various variants disclosed above, with respect to the method 100 apply with necessary changes to the present subsystem 500.

The subsystem 500 includes a 3D imaging sensor 504 configured to obtain a 3D data representation of a 3D object that includes depth characteristics. The 3D data representation provides a comprehensive spatial description of the object. The 3D imaging sensor 504 can be implemented using various technologies such as structured light sensors, time-of-flight cameras, or laser scanners, capable of capturing detailed spatial information about the object's shape, surface features, and relative distances.

The subsystem 500 also includes processing circuitry 506 configured to perform multiple tasks. Prior to performing tasks, the processing circuitry 506 is configured to extract multiple view images from the 3D data representation of the 3D object. This extraction process involves generating 2D projections or renderings of the 3D object from different viewpoints. The processing circuitry 506 is configured to extract the multiple view images from a perspective of an arrangement of multiple virtual cameras. In an embodiment, the arrangement of the multiple virtual cameras is virtual cameras arranged at positions irregularly spherical around the 3D object. Such spherical arrangement places virtual cameras at the vertices of a dodecahedron surrounding the object, providing comprehensive coverage. In another embodiment, the arrangement of the multiple virtual cameras is virtual cameras arranged at positions in a circle around the 3D object. Such circular arrangement places cameras at regular intervals along a circular path around the object, typically elevated at a 30-degree angle from the ground plane.

The processing circuitry 506 is, then, configured to select a most influential view based on an assignment of importance scores using a Cosine similarity method between visual features detected by at least one pre-trained convolutional neural network (CNN), denoted as ψ. Herein, the processing circuitry 506 is configured to extract by the at least one pre-trained CNN ψ, a stack of feature maps fmᵢ of the detected visual feature from the extracted multiple view images Vᵢ before the predicting by a classification model. Following feature extraction, the processing circuitry 506 is configured to compare feature vectors obtained by the feature extraction based on their similarity using the Cosine Similarity, and assign an importance score to each feature vector. The processing circuitry 506 is configured to determine the importance score I of each feature vector fv as a Cosine distance between current fvᵢ and all other feature vectors.

In an embodiment, the processing circuitry 506 is configured to select the feature vector with highest importance score, Most Similar View (MSV), as the most influential view. Alternatively, the processing circuitry 506 is configured to select the feature vector with lowest importance score, Most Dissimilar View (MDV), as the most influential view.

The processing circuitry 506 is further configured to predict a classification of the 3D object based on the selected most influential view. Herein, the processing circuitry 506 is configured to classify, by a fully connected layer, the 3D object. The processing circuitry 506 is, then, configured to output a class of the 3D object.

Finally, the processing circuitry 506 is configured to perform the multiple tasks, including controlling the robotic manipulator 502 to grasp the 3D object based on the object class. This control involves generating appropriate grasping strategies and motion commands based on the recognized object type, enabling the robotic system to interact effectively with the classified object. The subsystem 500 thus provides a solution for 3D object recognition and manipulation, integrating advanced computer vision techniques with robotic control for practical applications in areas such as automated manufacturing, warehousing, and robotic assistance.

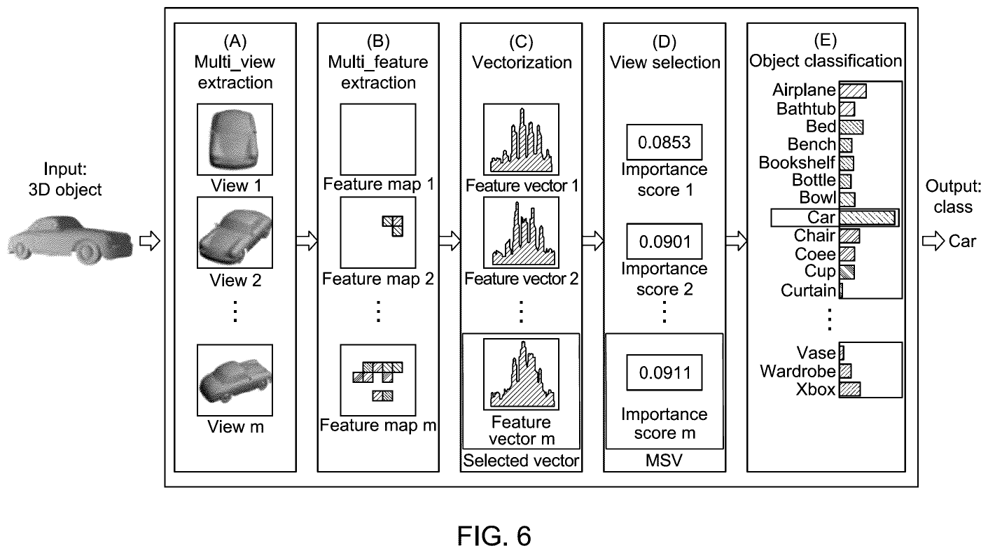

Referring now to FIG. 6, is a flow diagram for a method of predicting the class of a 3D object. The figure depicts the process of classifying a 3D object, in this case, a car, through five distinct phases. In phase A (Multi-View Extraction), the model generates m multi-view images from the input 3D object. The figure shows multiple 2D projections of the car from different angles. Phase B (Feature Extraction), involves extracting feature maps from each of the generated views using a pre-trained convolutional neural network (CNN). These feature maps are represented as grids, indicating the detected visual features. In phase C (Vectorization), the extracted feature maps are converted into feature vectors, visualized as bar graphs. Phase D (View Selection) assigns importance scores to each feature vector based on their cosine similarity. The figure displays these scores numerically, with the highest score (0.0853) corresponding to the MSV. This MSV is selected as the global descriptor for the object. Finally, in phase E (Object Classification), the selected global descriptor is utilized to classify the object using a pre-trained classifier. The output shows a probability distribution across different object classes, with “Car” having the highest probability, correctly identifying the input 3D object. This demonstrates how the model progresses from multi-view extraction to final classification, describing the importance of view selection based on importance scores in the classification process.

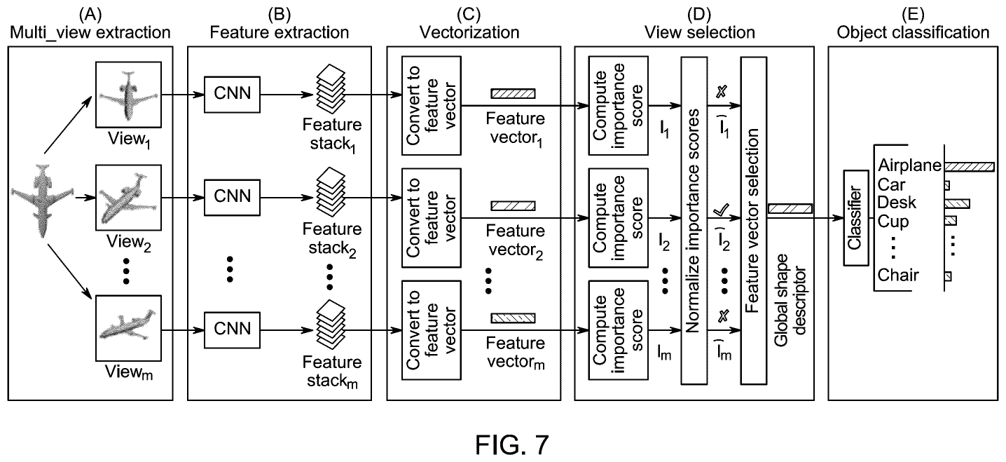

Referring to FIG. 7, a schematic diagram of an architecture is shown for a selective multi-view model, using an airplane as an exemplary 3D object. The figure depicts the five stages, as implemented by the model. Stage A performs multi-view extraction from multiple 2D views of the airplane extracted from different viewpoints and angles. These views provide diverse perspectives of the 3D object. Stage B performs feature extraction including feeding each extracted view into a pre-trained CNN. The CNN processes each view and outputs a corresponding feature stack, represented by green blocks, which contain the detected visual features. Stage C performs vectorization including converting the feature stacks generated by the CNN into feature vectors. This conversion is represented by the transition from the stacks to bar graphs, each representing a feature vector corresponding to a specific view. Stage D performs view selection including comparing the feature vectors based on their similarity using Cosine Similarity. The comparison results in importance scores (represented by I₁, I₂, . . . , Iₙ) assigned to each feature vector. These scores are normalized, and the view with the highest score (indicated by a checkmark) is selected as the most discriminative view. This selected view becomes the global descriptor for the object. Stage E performs object classification including inputting the global descriptor, represented by the selected feature vector, into a classifier. The classifier predicts the class of the 3D object, outputting probabilities for different classes (Airplane, Car, Chair, Cup). In this example, the “Airplane” class shows the highest probability, correctly identifying the input object. This architecture demonstrates how the model processes a 3D object through multiple stages, from extracting various views to ultimately classifying the object based on the most discriminative view. The use of pre-trained CNNs and Cosine Similarity for view selection highlights the approach to efficiently identifying the most informative perspective of the 3D object for classification purposes.

### Examples

3D datasets for evaluation are presented, and the implementation details, including the computer hardware, operating system, programming language, and code editor, are specified. In addition, the evaluation metrics used to assess the classification performance are listed.

ModelNet is a large-scale 3D dataset provided in 2014 by Wu et al. from Princeton University's Computer Science Department. ModelNet is described in Zhirong Wu, Shuran Song, Aditya Khosla, Fisher Yu, Linguang Zhang, Xiaoou Tang, and Jianxiong Xiao. 2015. 3d shapenets: A deep representation for volumetric shapes. In Proceedings of the IEEE conference on computer vision and pattern recognition. 1912-1920, incorporated herein by reference in its entirety. The ModelNet dataset has two subsets, ModelNet10 and ModelNet40, mostly used in semantic segmentation, object classification, and recognition tasks. ModelNet40 contains manually cleaned 3D objects without color information that belong to 40 class categories. In the present experiments, and for a fair comparison, two versions of that dataset have been used for evaluation, based on the camera settings from the literature, as discussed below:
(a) ModelNet40v1 (Balanced and aligned dataset): In this version, the same training and testing splits of ModelNet40 as in Huang et al., Kanezaki et al., Su et al. (for example) were used for evaluation. Where for each category, they used the first 80 training objects (or all if there are less than 80) for training, and balanced testing, they used the first 20 testing objects. They used the circular camera configuration for each object to extract the 12 aligned views. So, they ended up with 3,983 objects in 40 categories consisting of 3,183 training objects (38,196 views) and 800 testing objects (9,600 views).
(b) ModelNet40v2 (Imbalanced and unaligned dataset): Here, the whole ModelNet40 as in Hamdi et al., Wang and Chen (for example) were used for evaluation. This original version of the dataset is not balanced where there is a diverse number of objects across diverse categories. It contains 12,311 3D objects split into 9,843 for training and 2,468 for testing. The literature used a spherical configuration to extract the 20 unaligned views from each object to end up with a total of 196,860 for training and 49,360 for testing.

The comparative evaluations were conducted using Visual Studio Code on a computer with Windows 11 Pro operating system 64-bit. This computer had: 1) 12th Gen Intel® CPU with Core™ i7-12700H 2.30 GHz, 2) NVIDIA GeForce RTX 3060 GPU, and 3) 32 GB RAM. The environment in all the evaluations was set to Tensorflow-gpu 2.10, Cuda 11.2, and Python 3.9. In the training phase of each evaluation, the classifiers were trained with all the features of the extracted views. In the testing phase, the 3D objects were classified using only their global descriptor, the features of a selected view.

In the training phases, the learning rate was initialized to 0.0001 and tested twice with 20 epochs as done by Wang and Chen, Wang and Wang; and to 30 epochs as done by Sun et al., Wang and Cai, Wei et al. The network structure was optimized using Stochastic Gradient Descent (SGD), unlike above references, because “Adam is well known to perform worse than SGD for image classification tasks” according to Gupta et al. [See: Aman Gupta, Rohan Ramanath, Jun Shi, and S Sathiya Keerthi. 2021. Adam vs. SGD: Closing the generalization gap on image classification. In OPT2021:13th Annual Workshop on Optimization for Machine Learning, incorporated herein by reference in its entirety]. The SGD was set with 0.9 momentum and 0.001 weight decay to avoid overfitting and accelerate model convergence. However, the batch size was set to 400 images (20 objects) and 384 images (32 objects) for the 20-view and the 12-view versions, respectively.

To evaluate the classification performance of the disclosed multi-view object classification model, overall and average accuracy metrics have been used as criteria for classification accuracy. Herein, Overall Accuracy (OA), also known as instance accuracy, is the testing samples that classified correctly to the total number of testing objects samples. OA can be calculated as in Qi et al. See Shaohua Qi, Xin Ning, Guowei Yang, Liping Zhang, Peng Long, Weiwei Cai, and Weijun Li. 2021. Review of multi-view 3D object recognition methods based on deep learning. Displays (2021), 102053, incorporated herein by reference in its entirety. Further, herein, Average Accuracy (AA), also known as class accuracy, is the mean or average accuracy of all the correctly classified testing objects corresponding to the same class. In other words, AA is the mean of the instance accuracy among all classes. AA can also be calculated as in Qi et al. It is worth mentioning that if the testing data were balanced, as in the case of ModelNet40v1, the GA would be equal to the AA. However, GA and AA will be different if the testing data is imbalanced, as in the case of ModelNet40v2.

The classification accuracy results of the disclosed models using the ModelNet40v1 and ModelNet40v2 datasets when the models trained for 30 epochs are summarized in Table 4 (below). Table 4 presents the outcomes of various evaluations conducted under different settings. It is worth noting that the disclosed approach achieves the best results, an GA of 83.63% and AA of 83.63%, when only a single view is used for classifying 3D objects. This is observed when the pre-trained ResNet-152 model is employed for feature extraction, and the FCN is used as the classifier, trained with 12 views from ModelNet40v1 dataset (model M₁₃ of Table 4). Additionally, when the same feature extractor is trained with 20 views from ModelNet40v1 dataset, the disclosed approach with the FCL classifier demonstrates competitive performance, achieving an OA of 83.7%, but with an AA of 80.39% (model M₁₅ of Table 4).

TABLE 4
Classification accuracy of disclosed model on ModelNet40v1 and ModelNet40v2
datasets rendered as 12 views and 20 views for each object, respectively.

| | | | | Selected | | | | | |
|---|---|---|---|---|---|---|---|---|---|
| Model | Feature | Classifier | | View | | ModelNet40v1 | | ModelNet40v2 | |
| # | Extractor | FCN | FCL | MSV | MDV | OA | AA | OA | AA |
| M₁ | VGG-16 | ✓ | | ✓ | | 78.00% | 78.00% | 63.25% | 53.95% |
| M₂ | | ✓ | | | ✓ | 69.00% | 69.00% | 52.87% | 41.29% |
| M₃ | | | ✓ | ✓ | | 80.87% | 80.87% | 75.93% | 70.83% |
| M₄ | | | ✓ | | ✓ | 73.30% | 73.3% | 70.54% | 64.47% |
| M₅ | VGG-19 | ✓ | | ✓ | | 79.50% | 79.50% | 64.22% | 55.48% |
| M₆ | | ✓ | | | ✓ | 70.50% | 70.49% | 54.38% | 44.51% |
| M₇ | | | ✓ | ✓ | | 81.13% | 81.13% | 75.41% | 70.05% |
| M₈ | | | ✓ | | ✓ | 73.88% | 73.88% | 70.14% | 63.15% |
| M₉ | ResNet-50 | ✓ | | ✓ | | 82.50% | 82.50% | 78.24% | 71.47% |
| M₁₀ | | ✓ | | | ✓ | 76.63% | 76.63% | 69.65% | 60.96% |
| M₁₁ | | | ✓ | ✓ | | 82.00% | 82.00% | 83.31% | 79.12% |
| M₁₂ | | | ✓ | | ✓ | 74.88% | 74.88% | 74.39% | 67.64% |
| M₁₃ | ResNet-152 | ✓ | | ✓ | | 83.63% | 83.63% | 80.99% | 76.30% |
| M₁₄ | | ✓ | | | ✓ | 75.50% | 75.50% | 66.20% | 71.15% |
| M₁₅ | | | ✓ | ✓ | | 82.75% | 82.75% | 83.70% | 80.39% |
| M₁₆ | | | ✓ | | ✓ | 75.25% | 75.25% | 72.53% | 64.31% |
| M₁₇ | GoogLeNet | ✓ | | ✓ | | 10.25% | 10.25% | 04.05% | 02.50% |
| M₁₈ | | ✓ | | | ✓ | 10.63% | 10.63% | 04.25% | 03.13% |
| M₁₉ | | | ✓ | ✓ | | 71.00% | 71.00% | 51.95% | 45.92% |
| M₂₀ | | | ✓ | | ✓ | 66.88% | 66.88% | 50.00% | 44.23% |

The subsequent description provides detailed discussions and analyses of the various factors that affect the classification performance, including the number of training views, the selected testing view, the feature extractor, and the classifier.

Grad-CAM [See: Ramprasaath R Selvaraju, Michael Cogswell, Abhishek Das, Ramakrishna Vedantam, Devi Parikh, and Dhruv Batra. 2017. Grad-cam: Visual explanations from deep networks via gradient-based localization. In Proceedings of the IEEE international conference on computer vision. 618-626, incorporated herein by reference in its entirety] uses the gradient to generate a visual explanation by highlighting the significant image regions. The outcome is explained by understanding the significance of each neuron in CNN's last convolutional layer using gradient information. Grad-CAM combined the high-resolution pixel-space gradient visualizations with the coarse localizations to gain the guided Grad-CAM visualizations that are both class-discriminative and high-resolution. Guided Grad-CAM was able to visualize the significant regions of the image that correspond to the output prediction in high resolution, even if multiple possible pieces of evidence in the image exist.

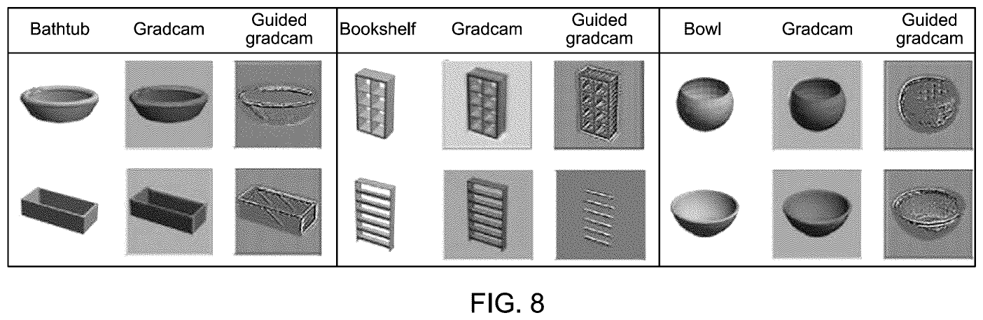

Here, the Grad-CAM technique was used to analyze the predicted labels to highlight the regions on the views responsible for the classification. FIG. 8 shows some correctly predicted views by the disclosed model with their corresponding feature maps highlighted with Guided GradCam showing the responsible regions that led to the correct classification. These feature maps show how the disclosed model selects the views that contain distinguishing features, such as shelves in bookshelves and circular edges in bowls.

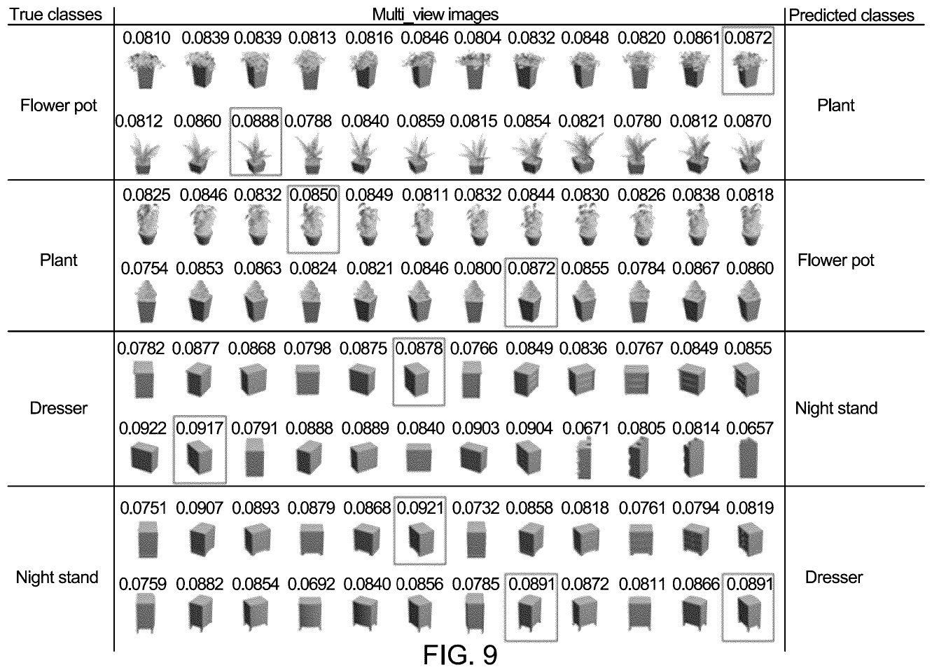

To gain further insights into the classification performance of the disclosed model, confusion matrices of model M₁₃ (the best result from the ModelNet40v1 dataset) and model M₁₅ (the best result from the ModelNet40v2 dataset) were constructed, which provide a detailed breakdown of the model's predictions across different classes. It was found that top confusions happened when: i) “flower pot” predicted as “plant”, ii) “dressers” predicted as “night stand”, and iii) “plant” predicted as “flower pot”. As shown in FIG. 9, even for human observers, distinguishing between these specific pairs of classes can be challenging due to the ambiguity present.

It was observed that the classification performance is influenced by the number of training views, specifically when using different feature extractors such as VGG-16, VGG-19, GoogLeNet, and ResNet architectures. When the feature extractors VGG-16, VGG-19, or GoogLeNet were utilized, increasing the number of training views resulted in a significant decrease in classification accuracy, ranging from 5.07% to 19.05% in terms of OA. However, when employing ResNet architectures as feature extractors, it was noticed a slight increase in classification accuracy as the number of training views increased, albeit by a small margin. The improvement ranged from 0.07% to 0.43% in terms of OA.

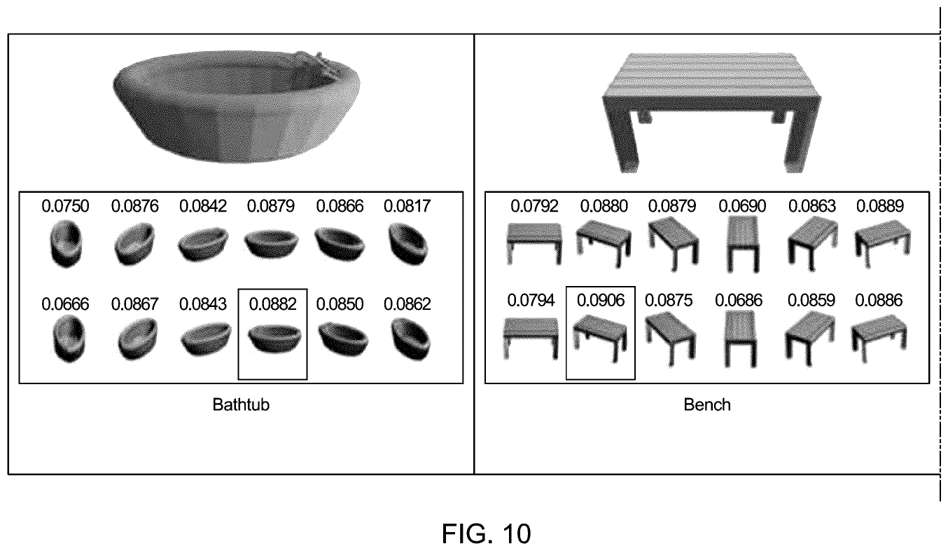

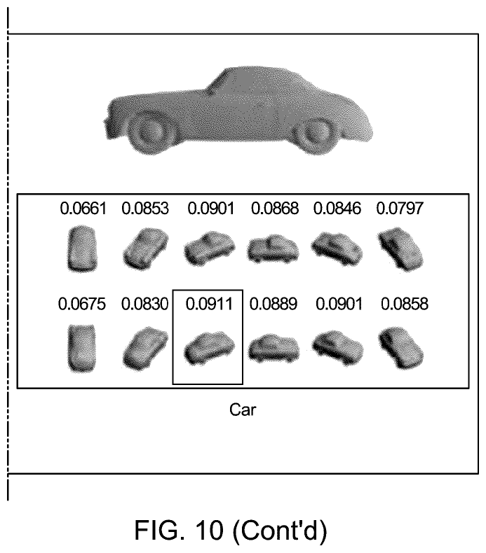

The results of the evaluations shown in Table 4 demonstrated that the accuracy of classification improves when using the single view MSV as global descriptors for categorizing 3D objects, regardless of any changes in the feature extractor or classifier. This suggests that the MSV (most similar view) is more effective in distinguishing objects than the MDV (most dissimilar view) because it captures the common and shared features found in most extracted views of the same object. So, the final model takes a 3D object as input, generates m views, gives them importance scores, selects the view with the highest score (MSV), and uses its feature vector to classify the object as shown in FIG. 10.

An important hyperparameter in the disclosed module is the choice of pre-trained CNN used for feature extraction. The performance of the disclosed model was evaluated using the different CNN architectures mentioned in Table 2 with the ModelNet40v1/v2 datasets. Also, the best results for each CNN architecture on ModelNet40v1/v2 were plotted. It was found that the highest performance on both datasets was obtained using ResNet-150 and ResNet-50, respectively. On the aligned ModelNet40v1 dataset, the disclosed model achieved an OA and AA of 83.63% and 83.63% using ResNet-150 and achieved a comparable performance of 82.88% OA and AA using ResNet-50. It is worth noting that OA and AA are equal in this dataset due to the balanced distribution of samples. On the more challenging unaligned ModelNet40v2 dataset, the disclosed model achieved an OA of 83.7% and an AA of 80.39% using ResNet-150 and achieved a comparable performance of 83.31% OA and 79.12% AA using ResNet-50. The increase in OA can be attributed to the larger number of samples, as more views were extracted from each object. However, the decrease in AA can be attributed to the imbalanced distribution of samples in the ModelNet40v2 dataset. In contrast, the performance on both datasets significantly dropped when using GoogLeNet. Furthermore, it was observed that the performance improves as the number of layers increases. This is because using more layers has the potential to capture finer details and features of 3D objects from the rendered 2D views. Conversely, using fewer layers may miss essential features and details, underutilizing the feature extractor's potential for improvement.

For understanding the effect of the classifiers, as discussed, the FCL and FCN classifiers were evaluated in the disclosed module. The training accuracy and loss curves for FCN and FCL from the best-performing evaluations is presented later. In the testing phase, the majority of conducted evaluations demonstrated that FCL consistently outperformed FCN (as indicated by the bold results in Table 4). Even in cases where FCN showed better performance, the disclosed model achieved comparable results when the classifier was replaced with FCL, as observed in models M₁₃ and M₁₅ from Table 4.

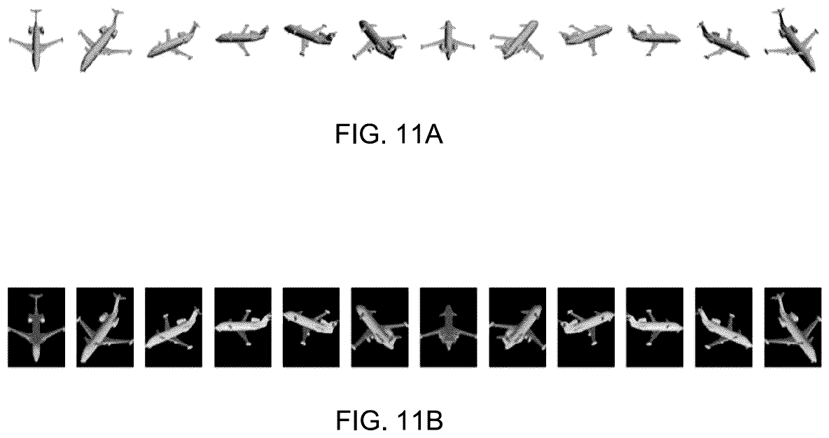

Further, the effect of shape representation on the classification of a single view for rendering 3D objects was investigated. ModelNet40v2 dataset was utilized for this evaluation, with 12 views per 3D object. However, each 3D object was rendered using the Phong shading technique [See: Phong Bui-Tuong. 1975. Illumination for computer generated pictures. CACM (1975), incorporated herein by reference in its entirety]. Shading techniques was demonstrated to improve performance in models such as MVDAN [See: Wang and Cai] and MVCNN [See: Jong-Chyi Su, Matheus Gadelha, Rui Wang, and Subhransu Maji. 2018. A deeper look at 3D shape classifiers. In Proceedings of the European Conference on Computer Vision (ECCV) Workshops, incorporated herein by reference in its entirety]. The rendered views were grayscale images with dimensions of 224×224 pixels and black backgrounds, as depicted in FIGS. 11A and 11B. The camera's field of view was adjusted so that the image canvas tightly encapsulated the 3D object.

Table 5 presents the results of the disclosed model when applied to the shaded ModelNet40v2 dataset with 12 views, utilizing ResNet-152 as the feature extractor. A comparison with the results presented in Table 4 for the shaded ModelNet40v2 dataset using ResNet-152 reveals a significant performance improvement, with a margin ranging from 4.3% to 9.57% OA. Specifically, the disclosed model classification performance increases from 83.7% to 88.13% OA when the shaded version of the dataset was employed. This demonstrates that enhancing the shape representation through shading techniques can improve the model's performance, even when utilizing only a single view for 3D object classification.

TABLE 5
Results of the disclosed (present) model
with shading as rendering technique.

| Selective | Selected | Classi- | 20 Epochs | | 30 Epochs | |
|---|---|---|---|---|---|---|
| Model | View | fier | OA | AA | OA | AA |
| Present model | MSV | FCN | 86.95% | 83.51% | 88.13% | 85.28% |
| Present model | MSV | FCL | 86.91% | 84.99% | 88.00% | 85.95% |
| Present model | MDV | FCN | 77.27% | 73.12% | 80.67% | 76.99% |
| Present model | MDV | FCL | 80.06% | 76.90% | 82.10% | 79.25% |

Further, to ensure a fair comparison of single-view 3D object classification, the results obtained by the disclosed approach were evaluated alongside the MVCNN and DeepCCFV models, as reported in Huang et al. These models were selected because they are deep learning-based (not transformer-based) and were tested in the same settings as explored. This includes utilizing the ModelNet40 dataset and experimenting with various CNNs as backbone networks.

Table 6 presents the comparison results. When the ModelNet40v1 dataset was used with 12 views, the disclosed model outperformed the MVCNN and DeepCCFV models, even in the absence of utilizing a shading technique. Remarkably, it is worth noting that despite all models using ResNet-50 as the feature extractor, the disclosed model achieved significantly higher accuracy, with a margin ranging from 13.24% to 35.52% OA. This notable improvement can be attributed to the selection mechanism employed in the disclosed model, which utilizes the most similar view (MSV).

TABLE 6
Comparison with the selective view-based 3D object classification
methods experimented with a single view.

| | ModelNet Dataset | | | | | | | |
|---|---|---|---|---|---|---|---|---|
| Selective | | | Shaded | Training | Selection | Feature | Accuracy | |
| Model | 40v1 | 40v2 | 40v1 | Views | Mechanism | Extractor | OA | AA |
| MVCNN | ✓ | | | 12 views | Random | VGG-11 | 64.28% | — |
| | | | | | selection | | | |
| MVCNN | ✓ | | | 12 views | Random | ResNet-50 | 48.11% | — |
| | | | | | selection | | | |
| DeepCCFV | ✓ | | | 12 views | Random | VGG11 | 82.11% | — |
| | | | | | selection | | | |
| DeepCCFV | ✓ | | | 12 views | Random | ResNet-50 | 70.39% | — |
| | | | | | selection | | | |
| Proposed | ✓ | | | 12 views | | ResNet-50 | 82.88% | 82.88% |
| Model | | | | | | | | |
| Proposed | ✓ | | | 12 views | Cosine | ResNet-152 | 83.63% | 83.63% |
| Model | | | | | Similarity | | | |
| Proposed | | ✓ | | 20 views | (MSV) | ResNet-50 | 83.31% | 79.12% |
| Model | | | | | | | | |
| Proposed | | ✓ | | 20 views | | ResNet-152 | 83.70% | 80.39% |
| Model | | | | | | | | |
| Proposed | | | ✓ | 12 views | | ResNet-152 | 88.00% | 85.95% |
| Model | | | | | | | | |

The present disclosure introduces a method for 3D object classification using a single testing view. The disclosed model involves extracting multi-view images from the 3D data representation and selecting the most discriminative views using the cosine similarity method as a selection mechanism. The disclosed model was evaluated on the ModelNet40 dataset, considering two different camera configurations for multi-view extraction. Additionally, evaluations were conducted to investigate the effect of various hyper-parameters on the classification performance of the disclosed model. These hyper-parameters included the number of training views, similarity selection mechanisms, pre-trained CNNs, and classifiers. The results demonstrate the effectiveness of the disclosed model in achieving 3D object classification using only a single testing view.

The present disclosure addresses significant limitations in current view-based 3D object classification methods. Existing approaches often utilize all captured views indiscriminately, including those that are not informative or useful for classification. This indiscriminate use of views can lead to confusion for the classifier and reduced efficiency. The selective multi-view method 100 for 3D object classification of the present disclosure overcomes these limitations by introducing an improved approach to view selection. The method 100 extracts multi-view images from 3D data representations and employs a selection process to identify the most discriminative views. This selection is based on importance scores derived from visual features detected by at least one pre-trained CNN. By focusing on the most influential views, the method 100 enhances classification accuracy while potentially reducing computational overhead.

The method 100 and the subsystem 500 of the present disclosure provide several clear advantages over existing techniques. The ability of the method 100 to identify a single, highly significant view that has the most influence on the prediction result represents a significant improvement in efficiency. This is achieved through the use of a Cosine Similarity technique, which allows for a nuanced comparison of feature vectors. By selecting only the most discriminative views, the method 100 reduces the amount of data that needs to be processed for classification, potentially leading to faster processing times and reduced computational requirements. Additionally, the use of pre-trained CNNs for feature extraction leverages transfer learning, potentially improving performance even with limited training data. These advantages collectively contribute to a more robust, efficient, and accurate approach to 3D object classification compared to existing techniques that rely on processing all available views. Next, further details of the hardware description of a computing environment according to exemplary embodiments is described with reference to FIG. 12. In FIG. 12, a controller 1200 is described is representative of processing circuitry 506, in which the controller 1200 is a computing device which includes a CPU 1201 which performs the processes described above/below. The process data and instructions may be stored in memory 1202. These processes and instructions may also be stored on a storage medium disk 1204 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1201, 1203 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1201 or CPU 1203 may be a Xenon or Core processor from Intel of America or an Opteron processor from AMD of America, or may be other processor types that would be recognized by one of ordinary skill in the art. Alternatively, the CPU 1201, 1203 may be implemented on an FPGA, ASIC, PLD or using discrete logic circuits, as one of ordinary skill in the art would recognize. Further, CPU 1201, 1203 may be implemented as multiple processors cooperatively working in parallel to perform the instructions of the inventive processes described above.

The computing device in FIG. 12 also includes a network controller 1206, such as an Intel Ethernet PRO network interface card from Intel Corporation of America, for interfacing with network 1260. As can be appreciated, the network 1260 can be a public network, such as the Internet, or a private network such as an LAN or WAN network, or any combination thereof and can also include PSTN or ISDN sub-networks. The network 1260 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1208, such as a NVIDIA GeForce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard.

A sound controller 1220 is also provided in the computing device such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the computing device. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

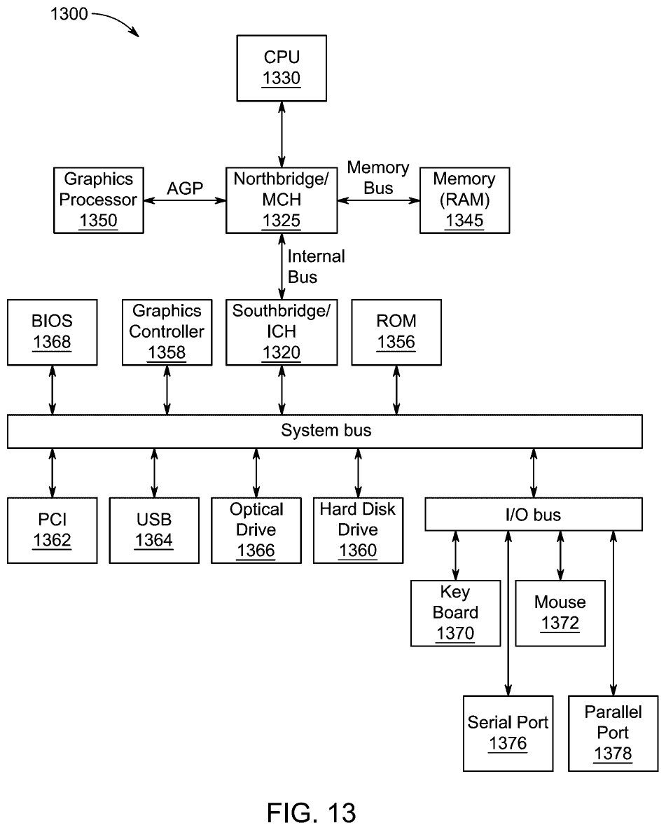

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 13.

FIG. 13 shows a schematic diagram of a data processing system, according to certain embodiments, for performing the functions of the exemplary embodiments. The data processing system is an example of a computer in which code or instructions implementing the processes of the illustrative embodiments may be located.

In FIG. 13, data processing system 1300 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1325. The NB/MCH 1325 also connects to the memory 1345 via a memory bus, and connects to the graphics processor 1350 via an accelerated graphics port (AGP). The NB/MCH 1325 also connects to the SB/ICH 1320 via an internal bus (e.g., a unified media interface or a direct media interface). The CPU Processing unit 1330 may contain one or more processors and even may be implemented using one or more heterogeneous processor systems.

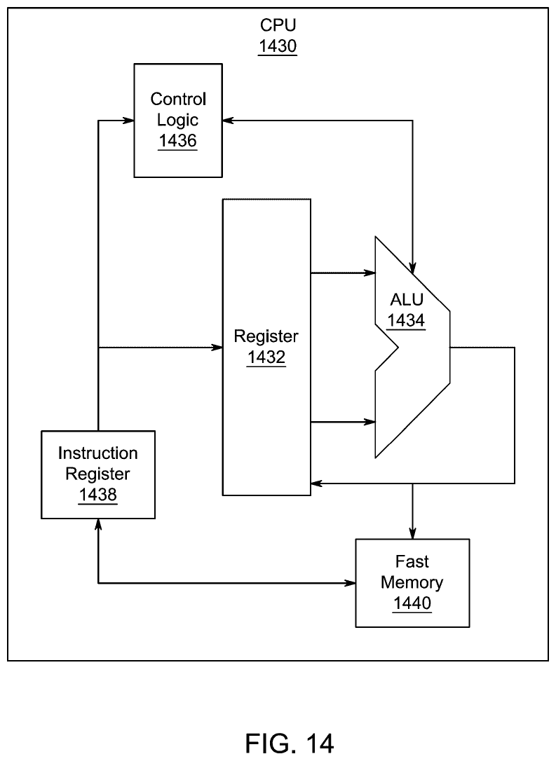

For example, FIG. 14 shows one implementation of CPU 1330. In one implementation, the instruction register 1438 retrieves instructions from the fast memory 1440. At least part of these instructions are fetched from the instruction register 1438 by the control logic 1436 and interpreted according to the instruction set architecture of the CPU 1330. Part of the instructions can also be directed to the register 1432. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be feedback into the register and/or stored in the fast memory 1440. According to certain implementations, the instruction set architecture of the CPU 1330 can use a reduced instruction set architecture, a complex instruction set architecture, a vector processor architecture, a very large instruction word architecture. Furthermore, the CPU 1330 can be based on the Von Neuman model or the Harvard model. The CPU 1330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 13, the data processing system 1300 can include that the SB/ICH 1320 is coupled through a system bus to an I/O Bus, a read only memory (ROM) 1356, universal serial bus (USB) port 1364, a flash binary input/output system (BIOS) 1368, and a graphics controller 1358. PCI/PCIe devices can also be coupled to SB/ICH 1388 through a PCI bus 1362.

The PCI devices may include, for example, Ethernet adapters, add-in cards, and PC cards for notebook computers. The Hard disk drive 1360 and CD-ROM 1366 can use, for example, an integrated drive electronics (IDE) or serial advanced technology attachment (SATA) interface. In one implementation the I/O bus can include a super I/O (SIO) device.

Further, the hard disk drive (HDD) 1360 and optical drive 1366 can also be coupled to the SB/ICH 1320 through a system bus. In one implementation, a keyboard 1370, a mouse 1372, a parallel port 1378, and a serial port 1376 can be connected to the system bus through the I/O bus. Other peripherals and devices that can be connected to the SB/ICH 1320 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

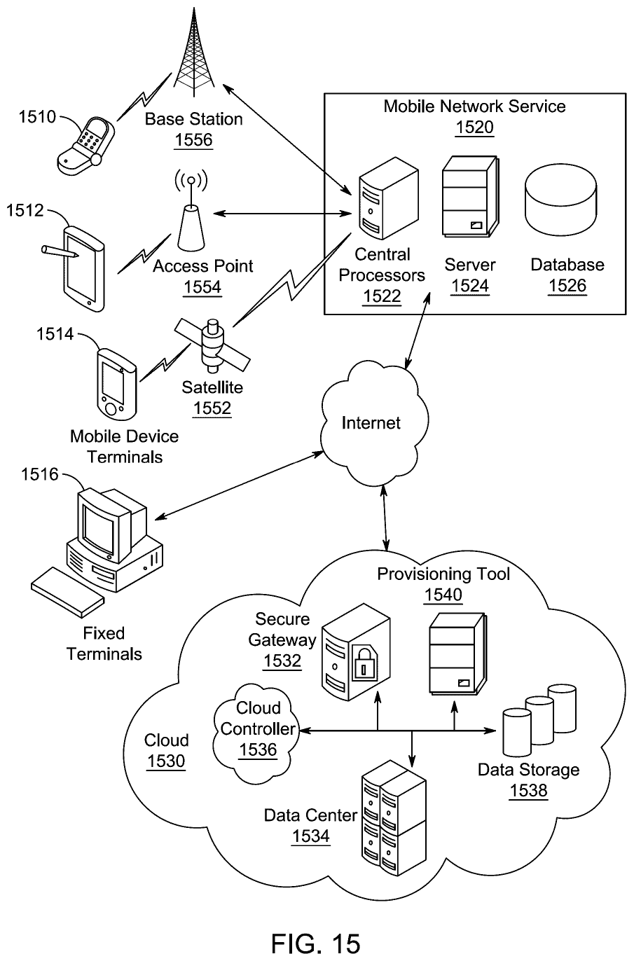

The functions and features described herein may also be executed by various distributed components of a system. For example, one or more processors may execute these system functions, wherein the processors are distributed across multiple components communicating in a network. The distributed components may include one or more client and server machines, such as cloud 1530 including a cloud controller 1536, a secure gateway 1532, a data center 1534, data storage 1538 and a provisioning tool 1540, and mobile network services 1520 including central processors 1522, a server 1524 and a database 1526, which may share processing, as shown by FIG. 15, in addition to various human interface and communication devices (e.g., display monitors 1516, smart phones 1510, tablets 1512, personal digital assistants (PDAs) 1514). The network may be a private network, such as a LAN, satellite 1552 or WAN 1554, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A selective multi-view method for 3D object classification, comprising:
inputting, by a 3D imaging sensor, a 3D data representation of a 3D object;
extracting, by processing circuitry, multiple view images from the 3D data representation of the 3D object;
selecting, by the processing circuitry, a most influential view based on an assignment of importance scores using a Cosine similarity method between visual features detected by at least one pre-trained convolutional neural network (CNN);
predicting, by the processing circuitry, a classification of the 3D object based on the selected most influential view; and
outputting, by the processing circuitry, a class of the 3D object.

2. The method of claim 1, further comprising controlling a robotic manipulator to grasp the 3D object based on the object class.

3. The method of claim 1, further comprising feature extracting, by the at least one pre-trained CNN ψ, a stack of feature maps fmᵢ of a detected visual feature from the extracted multiple view images Vᵢ before the predicting by a classification model.

4. The method of claim 3, further comprising comparing feature vectors obtained by the feature extracting based on their similarity using the Cosine Similarity, and assigning an importance score to each feature vector.

5. The method of claim 4, further comprising determining the importance score I of each feature vector fv as a Cosine distance between current fvᵢ and all other feature vectors.

6. The method of claim 5, further comprising selecting the feature vector with highest importance score, Most Similar View (MSV), as the most influential view.

7. The method of claim 5, further comprising selecting the feature vector with lowest importance score, Most Dissimilar View (MDV), as the most influential view.

8. The method of claim 1, wherein the extracting step extracts the multiple view images from a perspective of an arrangement of a plurality of virtual cameras arranged at positions irregularly spherical around the 3D object.

9. The method of claim 1, wherein the extracting step extracts the multiple view images from a perspective of an arrangement of a plurality of virtual cameras arranged at positions in a circle around the 3D object.

10. The method of claim 1, further comprising classifying, by a fully connected layer, the 3D object.

11. A 3D object recognition subsystem for a robotic pick and place manipulator, comprising:
a 3D imaging sensor obtaining a 3D data representation of a 3D object;
processing circuitry configured to
extract multiple view images from the 3D data representation of the 3D object,
select a most influential view based on an assignment of importance scores using a Cosine similarity method between visual features detected by at least one pre-trained convolutional neural network (CNN),
predict a classification of the 3D object based on the selected most influential view,
output a class of the 3D object, and
control the robotic manipulator to grasp the 3D object based on the object class.

12. The subsystem of claim 11, wherein the processing circuitry is further configured to extract the multiple view images from a perspective of an arrangement of a plurality of virtual cameras.

13. The subsystem of claim 11, wherein the processing circuitry is further configured to extract by the at least one pre-trained CNN ψ, a stack of feature maps fmᵢ of the detected visual feature from the extracted multiple view images Vᵢ before the predicting by a classification model.

14. The subsystem of claim 11, wherein the processing circuitry is further configured to
compare feature vectors obtained by the feature extraction based on their similarity using the Cosine Similarity, and
assign an importance score to each feature vector.

15. The subsystem of claim 14, wherein the processing circuitry is further configured to determine the importance score I of each feature vector fv as a Cosine distance between current fvᵢ and all other feature vectors.

16. The subsystem of claim 15, wherein the processing circuitry is further configured to select the feature vector with highest importance score, Most Similar View (MSV), as the most influential view.

17. The subsystem of claim 15, wherein the processing circuitry is further configured to select the feature vector with lowest importance score, Most Dissimilar View (MDV), as the most influential view.

18. The subsystem of claim 12, wherein the arrangement of the plurality of virtual cameras is virtual cameras arranged at positions irregularly spherical around the 3D object.

19. The subsystem of claim 12, wherein the arrangement of the plurality of virtual cameras is virtual cameras arranged at positions in a circle around the 3D object.

20. The subsystem of claim 11, wherein the processing circuitry is further configured to classify, by a fully connected layer, the 3D object.
